(19) United States
(12) Patent Application Publication
(10) Pub. No.: US 2013/0144635 A1
(43) Pub. Date: Jun. 6, 2013

(54) PROVIDING SURVEYS TO CARE PROVIDERS

(71) Applicants: BRIAN BERTHA, DANVILLE, CA (US); DARREN O'NEILL, SAN FRANCISCO, CA (US); STAN KACHNOWSKI, TARRYTOWN, NY (US); COLE MANSHIP, NEW YORK, NY (US); MARTHA TORRES-MORGAN, MARTINEZ, CA (US)

(72) Inventors: BRIAN BERTHA, DANVILLE, CA (US); DARREN O'NEILL, SAN FRANCISCO, CA (US); STAN KACHNOWSKI, TARRYTOWN, NY (US); COLE MANSHIP, NEW YORK, NY (US); MARTHA TORRES-MORGAN, MARTINEZ, CA (US)

(73) Assignee: MCKESSON SPECIALTY ARIZONA INC., SCOTTSDALE, AZ (US)

(21) Appl. No.: 13/309,278

(22) Filed: Dec. 1, 2011

(51) Int. Cl. G06Q 50/22

(52) U.S. Cl. 705/2

(57) ABSTRACT

Systems, methods, apparatus, and computer program products are provided for providing surveys to care providers. In one embodiment, health-related data can be used to trigger generating and providing surveys regarding medications and products to care providers.

### BACKGROUND

Care providers, such as pharmacists, are becoming increasingly involved in the delivery of patient care. For instance, there is an increasing need for the healthcare industry, pharmaceutical manufacturers, and research institutions to understand the needs, perspectives, and insights of various care providers. For example, a pharmaceutical manufacturer may want to know why prescriptions for a certain medication are significantly higher in some regions compared to others, or confirm that pharmacies in areas with unusually high pollen counts (or unexpected outbreaks of an infectious disease) have an adequate supply of the appropriate medications. Thus, a need exists for communicating with and receiving information from such care providers.

### BRIEF SUMMARY

In general, embodiments of the present invention provide systems, methods, apparatus, and computer program products for providing surveys to care providers.

In accordance with one aspect, a method for providing at least one survey to a care provider is provided. In one embodiment, the method comprises (1) determining whether health-related data satisfies one or more business rules for providing a survey; (2) after determining that the health-related data satisfies the one or more business rules for providing the survey, identifying a care provider corresponding to the health-related data; and (3) automatically providing the survey to the care provider, wherein the survey is associated with the health-related data.

In accordance with another aspect, a computer program product for providing at least one survey to a care provider is provided. The computer program product may comprise at least one computer-readable storage medium having computer-readable program code portions stored therein, the computer-readable program code portions comprising executable portions configured to (1) determine whether health-related data satisfies one or more business rules for providing a survey; (2) after determining that the health-related data satisfies the one or more business rules for providing the survey, identify a care provider corresponding to the health-related data; and (3) automatically provide the survey to the care provider, wherein the survey is associated with the health-related data.

In accordance with yet another aspect, an apparatus comprising at least one processor and at least one memory including computer program code is provided. In one embodiment, the at least one memory and the computer program code may be configured to, with the processor, cause the apparatus to at least (1) determine whether health-related data satisfies one or more business rules for providing a survey; (2) after determining that the health-related data satisfies the one or more business rules for providing the survey, identify a care provider corresponding to the health-related data; and (3) automatically provide the survey to the care provider, wherein the survey is associated with the health-related data.

### BRIEF DESCRIPTION OF THE SEVERAL VIEWS OF THE DRAWING(S)

Reference will be made to the accompanying drawings, which are not necessarily drawn to scale, and wherein:

FIG. 1 is a diagram of a system that can be used to practice various embodiments of the present invention.

FIG. 2 is a schematic of a data management system that may be used in association with certain embodiments of the present invention.

FIG. 3 is a flowchart illustrating operations and processes that can be used in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Methods, Apparatus, Systems, and Computer Program Products

As should be appreciated, various embodiments may be implemented in various ways, including as methods, apparatus, systems, or computer program products. Accordingly, various embodiments may take the form of an entirely hardware embodiment or an embodiment in which a processor is programmed to perform certain steps. Furthermore, various implementations may take the form of a computer program product on a computer-readable storage medium having computer-readable program instructions embodied in the storage medium. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

### II. Exemplary System Architecture

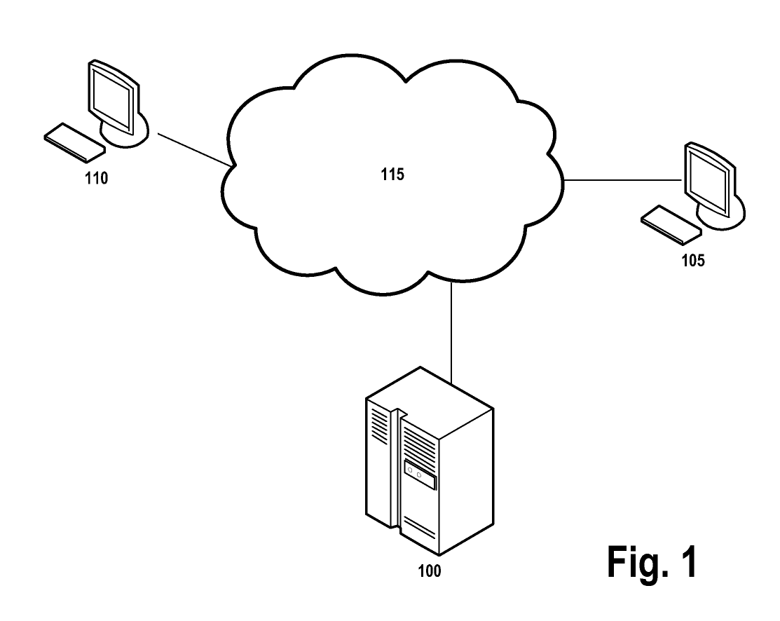

FIG. 1 provides an illustration of a system that can be used in conjunction with various embodiments of the present invention. As shown in FIG. 1, the system may include one or more data management systems 100, one or more third party computing devices 105, one or more care provider computing devices 110, and one or more networks 115. Each of the components of the system may be in electronic communication with, for example, one another over the same or different wireless or wired networks including, for example, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities, the various embodiments are not limited to this particular architecture.

### 1. Exemplary Data Management System

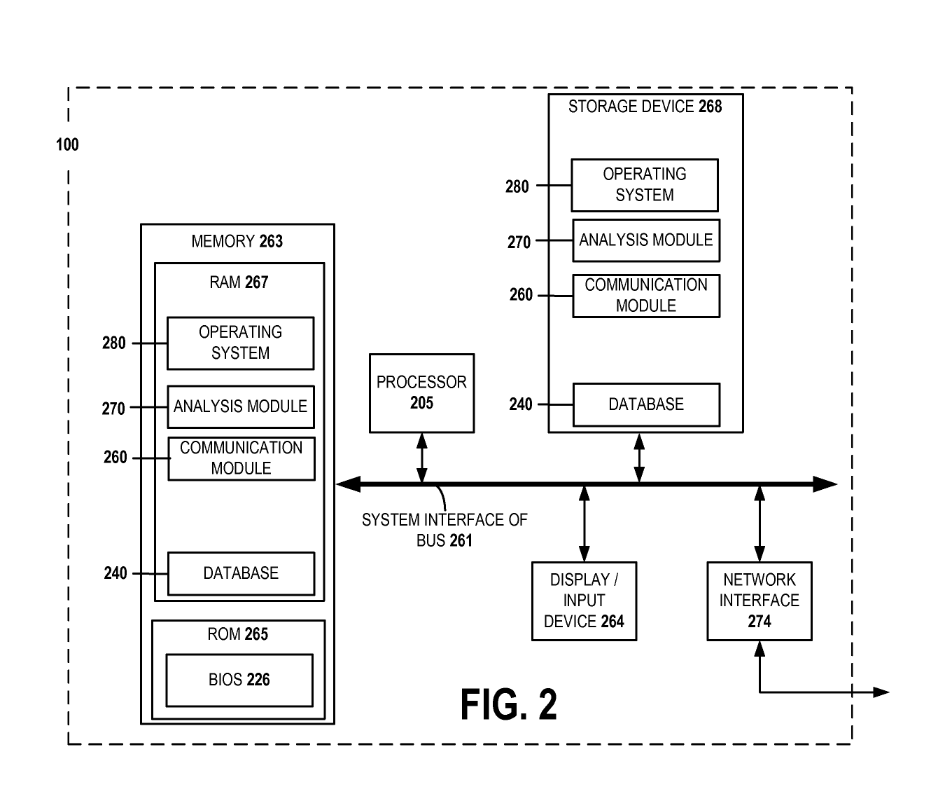

FIG. 2 provides a schematic of a data management system 100 according to one embodiment of the present invention. In some embodiments, the data management system 100 may be associated with an organization engaged in healthcare-related services. Further, the data management system 100 may be associated with an organization providing a service associated with providing surveys to care providers.

In general, the term “system” may refer to, for example, any computer, computing device, mobile phone, mobile station, desktop, tablet, notebook or laptop, distributed system, server, blade, gateway, switch, processing device, or combination of processing devices adapted to perform the functions described herein. As will be understood from this figure, in one embodiment, the data management system 100 includes a processor 205 that communicates with other elements within the data management system 100 via a system interface or bus 261. The processor 205 may be embodied in a number of different ways. For example, the processor 205 may be embodied as a processing element, processing circuitry, a coprocessor, a controller or various other processing devices including integrated circuits such as, for example, an application specific integrated circuit (ASIC), a field programmable gate array (FPGA), a hardware accelerator, and/or the like.

In an exemplary embodiment, the processor 205 may be configured to execute instructions stored in memory or otherwise accessible to the processor 205. As such, whether configured by hardware or software methods, or by a combination thereof, the processor 205 may represent an entity capable of performing operations according to embodiments of the present invention when configured accordingly. A display device/input device 264 for receiving and displaying data may also be included in the data management system 100. This display device/input device 264 may be, for example, a keyboard or pointing device that is used in combination with a monitor. The data management system 100 may further include transitory and non-transitory memory 263, which may include both random access memory (RAM) 267 and read only memory (ROM) 265. The data management system's ROM 265 may be used to store a basic input/output system (BIOS) 226 containing the basic routines that help to transfer information to the different elements within the data management system 100.

In addition, in one embodiment, the data management system 100 may include at least one storage device 268, such as a hard disk drive, a CD drive, and/or an optical disk drive for storing information on various computer-readable media. The storage device(s) 268 and its associated computer-readable media may provide nonvolatile storage. The computer-readable media described above could be replaced by any other type of computer-readable media, such as embedded or removable multimedia memory cards (MMCs), secure digital (SD) memory cards, Memory Sticks, electrically erasable programmable read-only memory (EEPROM), flash memory, hard disk, and/or the like. Additionally, each of these storage devices 268 may be connected to the system bus 261 by an appropriate interface.

Furthermore, a number of executable instructions, applications, program modules, and/or the like may be stored by the various storage devices 268 and/or within RAM 267. Such executable instructions, applications, program modules, and/or the like may include an operating system 280, an analysis module 270, and a communication module 260. As discussed in more detail below, these executable instructions, applications, program modules, and/or the like may control certain aspects of the operation of the data management system 100 with the assistance of the processor 205 and operating system 280—although their functionality need not be modularized. In addition to the program modules, the data management system 100 may store or be in communication with one or more databases, such as database 240.

Also located within the data management system 100, in one embodiment, is a network interface 274 for interfacing with various computing entities (e.g., with one or more third party computing devices 105 and/or care provider computing devices 110). For example, the data management system 100 may be able to generate and provide surveys to care provider computing devices 110 and provide responses to such surveys to third party computing devices 105. This communication may be via the same or different wired or wireless networks (or a combination of wired and wireless networks). For instance, the communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the data management system 100 may be configured to communicate via wireless external communication networks using any of a variety of protocols, such as 802.11, general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth™ protocols, wireless universal serial bus (USB) protocols, and/or any other wireless protocol.

It will be appreciated that one or more of the data management system's 100 components may be located remotely from other data management system 100 components. Furthermore, one or more of the components may be combined and additional components performing functions described herein may be included in the data management system 100.

### 2. Exemplary Third Party Computing Device

Third parties may be pharmaceutical manufacturers, government organizations, healthcare-related entities or professionals, and/or the like. Such third parties may have an interest in receiving responses from targeted surveys from specific care providers. By targeting specific care providers, surveys can be provided to the care providers with the perhaps the greatest insight into a question or situation. As will be recognized, third parties may be associated with one or more different third party computing devices 105 that may be used in connection with embodiments of the present invention. The third party computing devices 105 may each include one or more components that are functionally similar to those of the data management system 100. For example, in one embodiment, each of the third party computing devices 105 may include: (1) a processor that communicates with other elements via a system interface or bus; (2) a display device/input device; (3) transitory and non-transitory memory; and (4) a communications interface. These architectures are provided for exemplary purposes only and are not limiting to the various embodiments. The term “computing device” is used generically to refer to any computer, computing device, mobile phone, mobile station, desktop, notebook or laptop, distributed system, server, blade, gateway, switch, processing device, or combination of processing devices adapted to perform the functions described herein.

### 3. Exemplary Care Provider Computing Device

Care providers may be doctors, hospitals, pharmacies, insurance providers, care managers, and/or other healthcare-related entities or professionals. Care providers may be associated with one or more different care provider computing devices 110 that may be used in connection with embodiments of the present invention, such as receiving surveys from the data management system 100 and providing responses to the same. The care provider computing devices 110 may each include one or more components that are functionally similar to those of the data management system 100 and/or third party computing device 105. For example, in one embodiment, each of the care provider computing devices 110 may include: (1) a processor that communicates with other elements via a system interface or bus; (2) a display device/input device; (3) transitory and non-transitory memory; and (4) a communications interface. As with the third party computing devices 105, the care provider computing devices 110 may be any computer, computing device, mobile phone, mobile station, desktop, notebook or laptop, distributed system, server, blade, gateway, switch, processing device, or combination of processing devices adapted to perform the functions described herein.

### III. Exemplary System Operation

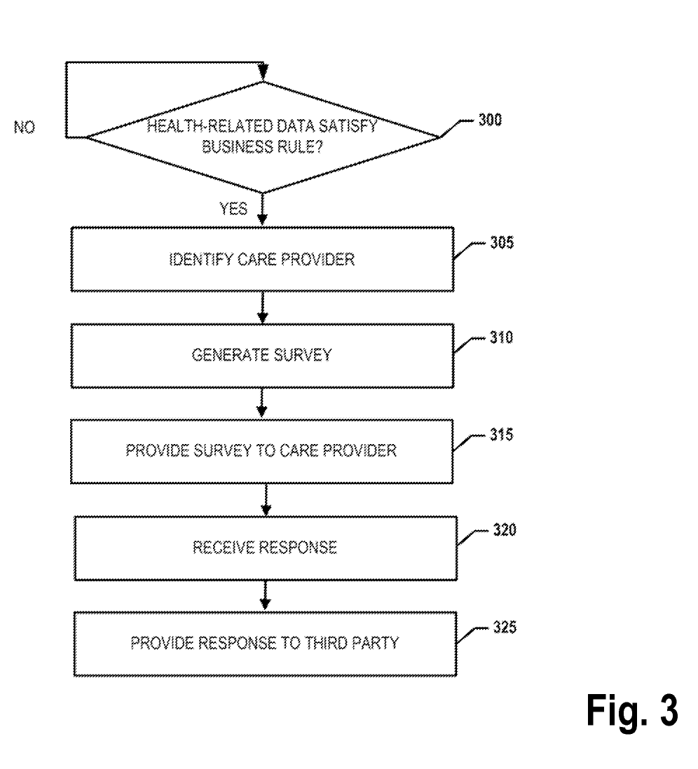

Reference will now be made to FIG. 3, which illustrates operations and processes that can be performed for providing surveys to care providers.

### 1. Care Providers and Care Provider Profiles

As indicated, care providers may be doctors, hospitals, pharmacies, insurance providers, care managers, and/or other healthcare-related entities or professionals. For example, a care provider may be the CVS Caremark organization. Similarly, a care provider may be the CVS Caremark Store located at 1943 Peachtree Road Northeast, Atlanta, Ga. 30309 (Store No. 20821943). Similarly, a care provider may be John Smith, a pharmacist or pharmacy technician who works at CVS Caremark Store No. 20821943.

In one embodiment, each care provider may be associated with one or more care provider profiles. Thus, the data management system 100 (and/or other computing device) may create and/or store various care provider profiles. Such care provider profiles may include the care provider's name, address, care provider identification number, and/or the like. Further, the care provider profile may include survey preferences (and/or other communication preferences). The survey preferences for a care provider may identify one or more formats for providing surveys to the care provider. The formats may include text messages (e.g., Short Message Service (SMS) and/or Multimedia Messaging Service (MMS)), email messages, uniform resource locators (URLs) to webpages, messages viewed using a software application resident on the care provider computing device 110, and/or the like. In addition to identifying one or more formats, a care provider profile may include electronic destination addresses (corresponding to the communication formats) to be used in providing surveys to the care provider.

By way of example, for email messages, the care provider may provide one or more email addresses for email accounts that are accessible via one or more care provider computing devices 110. Thus, for instance, if the care provider were the CVS Caremark organization, the email address provided may be pharmacy-surveys@cvscaremark.com. If the care provider were the CVS Caremark Store No. 20821943, the email address provided may be store-20821943@cvscaremark.com. And if the care provider were John Smith, a pharmacist or pharmacy technician who works at CVS Caremark Store No. 20821943, the email address provided may be john.smith@cvscaremark.com. As will also be recognized, a variety of other destination address and types can be used for providing surveys, such as Internet Protocol (IP) addresses, usernames, Media Access Control (MAC) addresses, phone numbers, Mobile Equipment Identifiers (MEID), and/or the like. As will be recognized, a variety of other techniques and approaches can be used to adapt to various needs and circumstances.

### 2. Health-Related Data/Information

In one embodiment, a computing device (e.g., data management system 100, third-party computing device 105, and/or care provider computing device 110) can receive, access, process, and/or analyze health-related data/information on a routine, periodic, and/or continuous basis. Health-related data/information may include various types of data/information, such as claims data/information, patient data/information, historical data/information, external data/information, and/or weather-related data/information.

In one embodiment, prescriptions may be used to request certain quantities of one or more medications. To assist in processing prescriptions, each prescription may include information, such as the patient's name, address, date of birth, medical/customer identification number, health insurance information, Social Security number, and/or the like. The care provider computing device 110 can process the prescriptions and then transmit claims data/information for the prescriptions to the data management system 100 (and/or other computing device) for processing, storage, and/or payment. Further, with access to claims data/information, the data management system 100 (and/or other computing device) can access, process, and/or analyze the claims data/information for specific indicators, events, factors, and/or triggers in accordance with one or more business rules (Block 300 of FIG. 3). For example, the data management system 100 (and/or other computing device) may identify/determine when a prescription for a particular medication has been requested, filled, or refilled (e.g., when a patient has a prescription filled for Proventil) or when an alternative medication to a medication of interest has been requested, filled, or refilled (e.g., when a patient has a prescription filled for Volmax). The data management system 100 (and/or other computing device) may also identify/determine when a patient switches medications (e.g., a patient switching from Proventil to Volmax) or experiences a change in medication regimes (e.g., when a particular patient's refills are now every other month instead of every month). In still another example, the data management system 100 (and/or other computing device) may identify/determine geographic areas (e.g., states, counties, cities, towns, zip codes, neighborhoods) associated with a decreased number of antiviral prescriptions being filled (e.g., a city or neighborhood in which the number of TAMIFLU prescriptions is below a predetermined threshold within a specific time period). As will be recognized, the data management system 100 (and/or other computing device) may receive, access, process, and/or analyze claims data/information to adapt to a variety of needs and circumstances.

In one embodiment, in addition to claims data/information, the data management system 100 (and other computing devices) may also receive, access, process, and/or analyze other health-related data/information, such as patient data/information and/or historical data/information from an electronic medical record (EMR) of a patient or from other data/information known about the patient from available sources, or from data/information provided by patients. This may include data/information regarding treatments, surgeries, schedules, spending habits, activity levels, insurance information, payment information, family history, interests, hobbies, and/or the like. Further, the data management system 100 (and/or other computing device) can access, process, and/or analyze the patient data/information and/or the historical data/information for specific indicators, events, factors, and/or triggers in accordance with one or more business rules (Block 300 of FIG. 3). For instance, such analysis may include analyzing the patient data/information and/or the historical data/information longitudinally (e.g., over a period of time). Analysis of the patient data/information and/or the historical data/information may be used to identify/determine patients being treated for a certain condition (and/or conditions), such as cancer or diabetes. Similarly, by longitudinally analyzing the patient data/information and/or the historical data/information, the data management system 100 (and/or other computing device) can evaluate how specific medications have been administered over a period of time, such as evaluating the prescribed dosage of Lipitor over the past three years. The data management system 100 (and/or other computing device) may also identify/determine particular conditions, programs, and/or treatments from a patient's medical history.

In one embodiment, the data management system 100 (and other computing devices) may also receive, access, process, and/or analyze other health-related data/information, such as external data/information from a variety of sources. For instance, environmental factors may have an impact on human health. Thus, external data/information may include weather-related data/information, such as data/information associated with thunderstorms, cold fronts, heat waves, tornados, hurricanes, pollen levels, chilly or damp conditions, precipitation, extreme temperatures, changes in barometric pressure, and/or the like. With access to the weather-related data/information, the data management system 100 (and/or other computing device) can access, process, and/or analyze the weather-related data/information for specific indicators, events, factors, and/or triggers in accordance with one or more business rules (Block 300 of FIG. 3). For example, the data management system 100 (and/or other computing device) may identify/determine geographic areas (e.g., states, counties, cities, towns, zip codes, neighborhoods) that may be subject to extreme temperature changes or increased pollen levels (e.g., the pollen level for zip code 30092 is currently above or is expected to be above a predetermined threshold within a specific time period).

In embodiment, external data/information may also include data/information from open source data/information providers, such as the government (e.g., health.data.gov) and/or private entities (e.g., Google). Such data/information may include census data/information, state cancer profile data/information, epidemiological data/information, food recall data/information, product recall data/information, disease outbreak data/information, survey data/information (e.g., including responses to surveys), chemical or toxic exposure data/information, food contamination data/information, food environment atlas data/information, demographic data/information, purchases data/information, sales data/information, socio-economic information data/information, vital statistics data/information, and/or the like. With access to such data/information, the data management system 100 (and/or other computing device) can access, process, and/or analyze the data/information for specific indicators, events, factors, and/or triggers in accordance with one or more business rules (Block 300 of FIG. 3). For instance, the data management system 100 (and/or other computing device) may identify/determine geographic areas (e.g., states, counties, cities, towns, zip codes, neighborhoods) that may be susceptible to certain disease outbreaks. Similarly, the data management system 100 (and/or other computing device) may identify/determine geographic areas (e.g., states, counties, cities, towns, zip codes, neighborhoods) that have sales of a certain medication (e.g., Volmax) above or below a predetermined threshold.

In one embodiment, the data management system 100 may also identify care providers (and care provider profiles) associated with the specific indicators, events, factors, and/or triggers for the health-related data/information that satisfies a one or more business rules (Block 305 of FIG. 3). As will be recognized, the data management system 100 (e.g., via the analysis module 270) may receive, access, process, and/or analyze various data/information to adapt to a variety of needs and circumstances.

### 3. Surveys and Responses

In one embodiment, health-related data/information may be accessed, processed, and/or analyzed for specific indicators, events, factors, and/or triggers in accordance with one or more business rules to generate, queue, and provide surveys (Blocks 310 and 315). Generally, a survey may be any form of one or more queries to collect data/information for analysis or feedback. The data can be used, for example, to understand or examine a condition, situation, or value. Such surveys can be generated using a variety of techniques and approaches. For example, a set of one or more business rules may define a standard template for a survey that can be populated by a computing device with the appropriate information based on the health-related data/information and/or care provider profiles. In another example, a set of one or more business rules may identify a pool of questions from which a computing device can draw to create a survey based on the events or characteristics of the health-related data and/or care provider profiles. In still another example, a computing device can dynamically generate questions for a survey based on the events or characteristics of the health-related data and/or care provider profiles.

As indicated, surveys can be generated and provided to care providers in a variety of ways. For example, the data management system 100 (or other computing device) can generate a survey to be automatically faxed or mailed to a care provider. Responses to such surveys can be faxed or mailed back by care providers and read and processed further by the data management system 100. In another embodiment, surveys can be delivered as text messages to a care provider's computing device 110. Responses to such surveys can be texted back to the data management system 100. In still another embodiment, surveys can be delivered and responded to via email clients, via a browser on a computing device, using interactive voice applications, via air-based holographic displays, through prosthetic computing devices integrated with the receiver's thoughts, vision, and/or hearing, via URLs, via messages viewed using a software application resident on a computing device, and/or the like.

In one embodiment, the surveys can be provided to care providers at specific times or within specific time windows within which it is more likely that a care provider will respond to the survey. Such time windows may correspond to peak or off-peak pharmacy times, the start or end of a care provider's shift or break, and/or the like.

After generating, queuing, and providing surveys to care providers, the data management system 100 can receive responses to the surveys (in similar manners as they can be provided) and/or aggregate the responses (Block 320 of FIG. 3). Further, when a care provider (e.g., via operation of a care provider computing device 110) provides a response to a survey, the data management system 100 can analyze the response and use it to intelligently generate a follow-up (e.g., additional) survey. Similarly, the data management system 100 can provide the responses to the appropriate third party (e.g., to the appropriate third party computing device 105, Block 325 of FIG. 3).

As will be recognized, a variety of other approaches and techniques can be used to adapt to various needs and circumstances.

### 4. Exemplary Application of Business Rules

In one embodiment, as indicated, the business rules for generating and providing surveys may be based on a variety of indicators, events, factors, and/or triggers. Such business rules can be applied to health-related data/information to trigger generating, queuing, and/or providing surveys to one or more care providers.

In one example, a third party (e.g., a pharmaceutical manufacturer) may want to better understand why the number of prescriptions filled for one of its medications is decreasing. Thus, business rules can be defined to determine, for example, which patients have switched from a medication of interest to a generic brand or a competing brand. In such cases, the business rules may also be defined to trigger generating and providing a survey to the care provider filling such a prescription as soon as the prescription has been requested and/or filled. For instance, the business rules may be defined to identify patients (or determine which patients are) switching from Proventil to Volmax. Thus, in response to (e.g., after) applying such business rules to health-related data and identifying one or more instances in which a patient switched from Proventil to Volmax, the data management system 100 (and/or other computing device) can identify the care providers who filled the corresponding prescription and generate, queue, and/or provide an appropriate survey to the care providers (e.g., John Smith, pharmacist or pharmacy technician for CVS). For example, the survey for John Smith may read “John, We noticed you switched Jane Doe from Proventil to Volmax. Is Ms. Doe unhappy with the effectiveness of Proventil?”

In a similar example, business rules can be defined to identify/determine instances in which prescriptions for a generic brand or a competing brand of a medication of interest are filled. For example, the business rules may be defined to trigger generating and providing surveys to care providers filling the prescriptions for all patients having a Volmax prescription filled for the first time. Thus, in response to (e.g., after) applying such business rules to health-related data and identifying one or more instances in which a patient had a Volmax prescription filled for the first time, the data management system 100 (and/or other computing device) can identify the care providers who filled such prescriptions and generate, queue, and/or provide an appropriate survey to the care providers (e.g., John Smith, pharmacist or pharmacy technician for CVS). In this example, the survey for John Smith may read “John, We noticed you filled a Volmax prescription for Jane Doe. Did you consider Proventil as more cost effective alternative? Also, how would you rate the effectiveness of Proventil on a scale of 1-10 (with 10 being the best)?” Such surveys can be provided to the appropriate the care provider computing device(s) 110 in a variety of ways and responded to by the care provider using similar approaches.

In another example, a third party (e.g., a pharmaceutical manufacturer) may want to identify/determine potential candidates for a new experimental medication. To do so, the business rules can be defined to identify patients whose patient data/information, historical data/information, and/or claims data/information indicate that the patients are being treated for a specific condition, such as cancer or diabetes. For identified patients, the business rules may be defined to trigger generating and providing a survey to the pharmacists filling their prescription or their primary care physicians. For instance, the business rules may be defined to identify patients who have diabetes. In response to (e.g., after) applying such business rules to health-related data and identifying one or more patients who are being treated for diabetes, the data management system 100 (and/or other computing device) can generate, queue, and/or provide a survey to the appropriate care provider. For example, a survey can be provided to the pharmacist (e.g., John Smith, pharmacist or pharmacy technician for CVS) or primary care physician for identified patients. The survey may read “Mr. Smith, We have developed a new oral medication for the treatment of diabetes. Do you think your patient Ms. Doe would be interested in participating in a free trial of the medication?” After providing such surveys to the appropriate care providers (e.g., via care provider computing devices 110), responses to the surveys can be received, tracked, and provided to any appropriate third parties, such as the pharmaceutical manufacturer that developed the new medication. The pharmaceutical manufacturer can the use the responses to contact and/or enroll the patients in the trial for the new medication.

In still another example, a third party (e.g., a pharmaceutical manufacturer) may want to better understand why medication sales of a particular medication are following a specific pattern or trend (e.g., increasing or decreasing) or whether a certain sales promotion is effective. Thus, the business rules can be defined to identify/determine geographic areas (e.g., states, counties, cities, towns, zip codes, neighborhoods) in which the sales of a medication or other product have dropped below a certain threshold (e.g., a zip code or neighborhood in which the number of TAMIFLU prescriptions is below a predetermined threshold within a specific time period) or exceeded a certain threshold. The business rules may also be defined to trigger generating and providing a survey to CVS pharmacists within the identified geographic areas (e.g., states, counties, cities, towns, zip codes, neighborhoods). For instance, by applying such business rules to the health-related data/information, the data management system 100 (and/or other computing device) may identify 30092 as a zip code in which the number of TAMIFLU prescriptions being filled within a specific time period has dropped below a certain threshold. In response to (e.g., after) such a determination, the data management system 100 (and/or other computing device) can generate, queue, and/or provide an appropriate survey to the CVS pharmacists and/or pharmacy technicians in or proximate to the 30092 zip code. Such surveys may read “Hello, The number of TAMIFLU prescriptions has declined since the TAMIFLU discount promotion stopped. Do you believe that is contributing to the decline in TAMIFLU prescriptions?” Or, the survey may read “Hello, The number of TAMIFLU prescriptions has declined by 12% over the past year. Do you know what is causing the decline? Do you expect the decline to continue?” After providing such surveys to the appropriate care providers, responses to the surveys can be received and provided to the third party by the data management system 100).

In still another example, a third party (e.g., a government entity or a pharmaceutical manufacturer) may want to better evaluate existing supplies and production of a certain medication or product based on the expected need for the medication or product. Thus, the business rules can be defined to identify geographic areas (e.g., states, counties, cities, towns, zip codes, neighborhoods) that may be subject to extreme temperature changes or increased pollen levels (such as geographic areas in which the pollen level is currently above or is expected to be above a predetermined threshold within a specific time period). Similarly, the business rules can be defined to identify geographic areas (e.g., states, counties, cities, towns, zip codes, neighborhoods) that may be susceptible to certain disease outbreaks. The business rules may also be defined to trigger generating and providing surveys to all CVS Stores within the identified geographic areas (e.g., states, counties, cities, towns, zip codes, neighborhoods). For instance, by applying such business rules to the health-related data/information, the data management system 100 (and/or other computing device) may identify Atlanta, Ga. as a geographic area expecting freezing temperatures or increased pollen levels within a specific period of time. In response to (e.g., after) such a determination, the data management system 100 (and/or other computing device) can generate, queue, and/or provide an appropriate survey to the all CVS stores in or proximate to Atlanta, Ga. Such surveys may read “Hello, With the expected cold front moving in, do you have enough NyQuil in stock to handle the usually spike in sales for such winter conditions?” Or, the survey may read “Hello, with the increasing pollen count, do you have sufficient eye drops and Albuterol to handle the likely increase in demand?” After providing such surveys to the appropriate care providers, responses to the surveys can be received, tracked, and provided to third parties, for example, to better understand the expected need of the medications or products.

In yet another example, a third party (e.g., pharmaceutical manufacturer) may want to receive pharmacists' perspectives on specific medications (or competing medications of a medication of interest). Thus, the business rules can be defined to identify/determine patients who have been taking Lipitor for over a period of three years. The business rules may also be defined to trigger generating and providing a survey to CVS pharmacists who filled prescriptions for such patients. For instance, by applying such business rules to the health-related data/information, the data management system 100 (and/or other computing device) may determine that John Doe has been taking Lipitor for over five years. Then, the data management system 100 (and/or other computing device) can identify Mr. Doe's primary pharmacist or pharmacy technician as John Smith and generate and provide a survey to Mr. Smith. Such a survey may read “Mr. Smith, How would you evaluate the effectiveness of Lipitor in the treatment of Mr. Doe on a scale of 1-10 (with 10 being extremely effective)?” After receiving responses to such surveys, the responses can be provided to any interested third parties.

In various embodiments, these approaches and techniques allow for the identification of potential respondents (e.g., care providers) with, for example, the greatest insight into a question and sending them targeted questions at the times when they are most likely to respond. After generating, queuing, and providing surveys to care providers, the data management system 100 can receive responses to the surveys and/or aggregate the responses. In one embodiment, the responses can be used generate and provide follow-up (e.g., additional) surveys to the care providers. Similarly, the data management system can provide the responses to the appropriate third party (e.g., to the appropriate third party computing device 105). As will be recognized, a variety of other approaches and techniques can be used to adapt to various needs and circumstances.

### IV. Conclusion

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for providing at least one survey to a care provider, the method comprising:
determining, via one or more processors, whether health-related data satisfies one or more business rules for providing a survey;
after determining that the health-related data satisfies the one or more business rules for providing the survey, identifying, via the one or more processors, a care provider corresponding to the health-related data; and
automatically providing, via the one or more processors, the survey to the care provider, wherein the survey is associated with the health-related data.

2. The method of claim 1 further comprising storing survey preferences for the care provider that identify at least one communication format and at least one electronic destination address to be used in providing surveys to the care provider.

3. The method of claim 1, wherein the health-related data comprises claims data and external data.

4. The method of claim 1 further comprising generating the survey.

5. The method of claim 4, wherein generating the survey is selected from the group consisting of (a) populating blank fields in a survey template, (b) dynamically generating the survey based at least in part on the health-related data, and (c) selecting the survey from a plurality of predefined surveys.

6. The method of claim 1 further comprising receiving a response to the survey from the care provider and providing at least a portion of the response to a third-party.

7. The method of claim 6 further comprising, after receiving the response to the survey from the care provider, providing an additional survey to the care provider based at least in part on the response.

8. A computer program product for providing at least one survey to a care provider, the computer program product comprising at least one computer-readable storage medium having computer-readable program code portions stored therein, the computer-readable program code portions comprising:
an executable portion configured to determine whether health-related data satisfies one or more business rules for providing a survey;
an executable portion configured to, after determining that the health-related data satisfies the one or more business rules for providing the survey, identify a care provider corresponding to the health-related data; and
an executable portion configured to automatically provide the survey to the care provider, wherein the survey is associated with the health-related data.

9. The computer program product of claim 8 further comprising an executable portion configured to store survey preferences for the care provider that identify at least one communication format and at least one electronic destination address to be used in providing surveys to the care provider.

10. The computer program product of claim 8, wherein the health-related data comprises claims data and external data.

11. The computer program product of claim 8 further comprising an executable portion configured to generate the survey.

12. The computer program product of claim 11, wherein generating the survey is selected from the group consisting of (a) populating blank fields in a survey template, (b) dynamically generating the survey based at least in part on the health-related data, and (c) selecting the survey from a plurality of predefined surveys.

13. The computer program product of claim 8 further comprising an executable portion configured to receive a response to the survey from the care provider and provide at least a portion of the response to a third-party.

14. The computer program product of claim 13 further comprising an executable portion configured to, after receiving the response to the survey from the care provider, provide an additional survey to the care provider based at least in part on the response.

15. An apparatus comprising at least one processor and at least one memory including computer program code, the at least one memory and the computer program code configured to, with the processor, cause the apparatus to at least:
determine whether health-related data satisfies one or more business rules for providing a survey;
after determining that the health-related data satisfies the one or more business rules for providing the survey, identify a care provider corresponding to the health-related data; and
automatically provide the survey to the care provider, wherein the survey is associated with the health-related data.

16. The apparatus of claim 15, wherein the memory and computer program code are further configured to, with the processor, cause the apparatus to store survey preferences for the care provider that identify at least one communication format and at least one electronic destination address to be used in providing surveys to the care provider.

17. The apparatus of claim 15, wherein the health-related data comprises claims data and external data.

18. The apparatus of claim 15, wherein the memory and computer program code are further configured to, with the processor, cause the apparatus to generate the survey.

19. The apparatus of claim 18, wherein generating the survey is selected from the group consisting of (a) populating blank fields in a survey template, (b) dynamically generating the survey based at least in part on the health-related data, and (c) selecting the survey from a plurality of predefined surveys.

20. The apparatus of claim 15, wherein the memory and computer program code are further configured to, with the processor, cause the apparatus to receive a response to the survey from the care provider and provide at least a portion of the response to a third-party.

21. The apparatus of claim 20, wherein the memory and computer program code are further configured to, with the processor, cause the apparatus to, after receiving the response to the survey from the care provider, provide an additional survey to the care provider based at least in part on the response.
